(19) United States
(12) Patent Application Publication
(10) Pub. No.: US 2026/0194867 A1
(43) Pub. Date: Jul. 9, 2026

(54) GENERATION OF CONTROL INSTRUCTIONS TO CONTROL OPERATION OF CONVEYOR

(71) Applicant: International Business Machines Corporation, Armonk, NY (US)

(72) Inventors: Tushar Agrawal, West Fargo, ND (US); Fang Lu, Billerica, MA (US); Jeremy R. Fox, Georgetown, TX (US); Sarbajit Kumar Rakshit, Kolkata (IN)

(21) Appl. No.: 19/008,708

(22) Filed: Jan. 3, 2025

(51) Int. Cl. G05B 13/02; B64U 10/13; B64U 101/31; G06T 1/00; G06T 7/00; G07C 5/08

(52) U.S. Cl. CPC G05B 13/0265; B64U 10/13; G06T 1/0014; G06T 7/0002; G07C 5/0808; B64U 2101/31; B64U 2201/20

(57) ABSTRACT

Generation of control instructions to control operation of conveyor includes receiving image data associated with each section of a plurality of sections of a conveyor. Each section of the plurality of sections includes at least one adjustable supporting structure. The operational data associated with the conveyor is received. An artificial intelligence (AI) model is applied on the image data and the operational data. Anomaly data is determined for an anomaly associated with the conveyor. A set of control instructions are generated based on the anomaly data. The set of control instructions is associated with an operation of at the conveyor. The set of control instructions is outputted.

### BACKGROUND

The disclosure relates to the generation of control instructions and more particularly, to the generation of the control instructions for industry automation.

Conveyors such as vertical conveyor belts are vital components in industries that require efficient transport of raw materials across varying altitudes. Designed to facilitate an upward and downward movement of materials, the vertical conveyor belts ensure a safe and effective transfer from lower levels to higher elevations. The functionality of the vertical conveyor belts is critical in settings such as manufacturing, warehousing, and mining, where space optimization and material handling are needed for productivity.

A key feature of vertical conveyor belts is horizontal material gripping, which plays a significant role in securing raw materials during vertical lifting. By preventing materials from falling or shifting unexpectedly, the horizontal material gripping module enhances the safety and efficiency of the transportation process. The integration of advanced technologies and design elements in the vertical conveyor belts allows for improved material handling capabilities, ensuring that various types of raw materials can be transported effectively in diverse industrial applications.

### SUMMARY

In various embodiments of the disclosure, a computer-implemented method for generation of control instructions to control an operation of a conveyor is described. The computer-implemented method includes receiving, by a computer, image data associated with each section of a plurality of sections of a conveyor. Each section of the plurality of sections includes at least one adjustable supporting structure. The conveyor is configured to move a plurality of entities positioned thereon. The computer-implemented method further includes receiving, by the computer, operational data associated with the conveyor. The computer-implemented method further includes applying, by the computer, an artificial intelligence (AI) model on the image data and the operational data. The computer-implemented method further includes determining, by the computer, anomaly data for an anomaly associated with the conveyor. The anomaly data is determined based on the application of the AI model. The anomaly is associated with at least one of a movement of the conveyor, a specific entity of the plurality of entities, or the at least one adjustable supporting structure of a specific section of the plurality of sections. The computer-implemented method further includes generating, by the computer, a set of control instructions based on the anomaly data. The set of control instructions is associated with an operation of the conveyor. The computer-implemented method further includes outputting, by the computer, the set of control instructions.

In various embodiments of the disclosure, a computer system for generation of control instructions to control an operation of a conveyor is described. The computer system includes a processor set, a computer-readable storage media, and program instructions that are stored on the one or more computer-readable storage media. The program instructions are executable by the processor set to cause the processor set to receive image data associated with each section of a plurality of sections of a conveyor. Each section of the plurality of sections includes at least one adjustable supporting structure. The conveyor is configured to move a plurality of entities positioned thereon. The program instructions further cause the processor set to receive operational data associated with the conveyor. The program instructions further cause the processor set to apply an artificial intelligence (AI) model to the image data and the operational data. The program instructions further cause the processor set to determine anomaly data for an anomaly associated with the conveyor. The anomaly data is determined based on the application of the AI model. The anomaly is associated with at least one of a movement of the conveyor, a specific entity of the plurality of entities, or the at least one adjustable supporting structure of a specific section of the plurality of sections. The program instructions further cause the processor set to generate a set of control instructions based on the anomaly data. The set of control instructions is associated with an operation of at least one of the conveyor, or an aerial vehicle. The program instructions further cause the processor set to control the operation of at least one of the conveyor, or the aerial vehicle based on the set of control instructions.

In various embodiments of the disclosure, a computer program product for the generation of control instructions to control an operation of a conveyor is described. The computer program product includes a computer-readable storage media having program instructions stored on the computer-readable storage media to perform operations. The operations include receiving image data associated with each section of a plurality of sections of the conveyor. Each section of the plurality of sections includes at least one adjustable supporting structure. The conveyor is configured to move a plurality of entities positioned thereon. The operations further include receiving operational data associated with the conveyor. The operations further include applying an artificial intelligence (AI) model to the image data and the operational data. The operations further include determining anomaly data for an anomaly associated with the conveyor. The anomaly data is determined based on the application of the AI model. The anomaly is associated with at least one of a movement of the conveyor, a specific entity of the plurality of entities, or the at least one adjustable supporting structure of a specific section of the plurality of sections. The operations further include generating a set of control instructions based on the anomaly data. The set of control instructions is associated with an operation of the conveyor. The operations further include outputting the set of control instructions.

Additional technical features and benefits are realized through the process of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment generation of control instructions to control an operation of a conveyor, in accordance with an embodiment of the disclosure;

FIG. 2 is a diagram that illustrates an environment for the generation of the control instructions to control the operation of the conveyor, in accordance with an embodiment of the disclosure;

FIG. 3 is a diagram that illustrates one or more operations performed by the system for the generation of the control instructions to control the operation of the conveyor, in accordance with an embodiment of the disclosure;

FIG. 4A is a diagram that illustrates one or more operations performed by the system for controlling an operation of a specific aerial vehicle based on a set of control instructions, in accordance with an embodiment of the disclosure;

FIG. 4B is a diagram that illustrates an exemplary scenario for controlling an operation of a first aerial vehicle based on the set of control instructions, in accordance with an embodiment of the disclosure;

FIG. 5A is a diagram that illustrates a method flowchart for the generation of anomaly data based on entity data, in accordance with an embodiment of the disclosure;

FIG. 5B is a diagram that illustrates a method flowchart for the generation of the set of control instructions based on height data and size data, in accordance with an embodiment of the disclosure;

FIG. 6 is a diagram that illustrates an exemplary scenario for generating the set of control instructions for performing the adjustment operation, in accordance with an embodiment of the disclosure;

FIG. 7 is a diagram that illustrates one or more operations for training the AI model based on historical operation data, simulation environment, and virtual operational data, in accordance with an embodiment of the disclosure;

FIG. 8 is a diagram that illustrates a flowchart of an exemplary method for the generation of the set control instructions to control the operation of the conveyor, in accordance with an embodiment of the disclosure.

### DETAILED DESCRIPTION

A conveyor is a mechanical system designed to transport goods, materials, or products from a first location to a second location within a facility or a production line. The conveyors are intensively used in industries such as, but not limited to, manufacturing, warehousing, and logistics, due to the efficiency of the conveyor and ability to handle a range of materials. There are multiple types of conveyors such as, but not limited to, belt conveyors, roller conveyors, screw conveyors, chain conveyors, and bucket conveyors. Furthermore, the conveyor may be assembled in a horizontal alignment or a vertical alignment to transport the goods from the first location to the second location.

In the case of the conveyor being assembled vertically, an adjustable supporting structure such as (a horizontal material gripping module) of the conveyor plays a significant role in ensuring efficient and reliable transportation of the goods, the materials, or the products from the first location (lower altitude) to the second location (higher altitude). The efficient and reliable operation of the conveyor may ensure that the conveyor operates without any break-down or malfunction, the goods transported using the conveyor reach in time, and the goods are transported without any negative effect thereon. For example, the reliable transportation may be achieved by precisely controlling the movement and positioning of the goods, the materials, or the products on the conveyor and using support structure, such as the adjustable supporting structure. Moreover, efficiency in the operation of the conveyor may be achieved by ensuring that the conveyor operates within desired condition of operation to ensure smooth and stable transportation, minimizing the risk of damage, loss, or misalignment of conveyed items.

In various circumstances, the adjustable supporting structure of the conveyor is subjected to various challenges, including wear and tear, breakage, and loosening. These issues can arise from a size, a dimension, and a type of goods (such as raw materials) being transported, which may exert varying degrees of pressure and stress on the adjustable supporting structure. For instance, larger or heavier raw materials may lead to increased friction and strain on the adjustable supporting structure, while smaller or lighter raw materials could result in inadequate grip, causing slippage or misalignment. As a result, the longevity and operational efficiency of the conveyor can be significantly compromised, leading to potential downtime, increased maintenance costs, and reduced productivity.

To address these challenges, it is beneficial to implement a method and a system that adapts to changing characteristics of the raw materials being transported on the conveyor. A first approach can be the alteration of a height of the adjustable supporting structure, which can be dynamically adjusted based on real-time assessments of the raw material characteristics. By incorporating one or more sensors, the disclosed system continuously evaluates the size, weight, and composition of the raw materials placed on the adjustable supporting structure of the conveyor. This data is further utilized to automatically adjust a height of the adjustable supporting structure, ensuring adequate contact and pressure distribution across the raw materials. Such adaptability not only enhances the grip but also mitigates the risk of free fall and wear and tear, ultimately extending the lifespan of the conveyor.

Moreover, the disclosed system can lead to significant improvements in overall reliability and efficiency of conveyor operation. By ensuring that the adjustable supporting structure is in a suitable position relative to the raw materials being transported, the system maintains consistent flow and reduces the likelihood of raw material jams or misalignments. This approach minimizes the need for frequent maintenance interventions, allowing for smoother operations and less downtime. Further, by enhancing the reliability of the conveyor, business operations achieve higher throughput rates and improved productivity, resulting in better overall performance and cost-effectiveness. Reliability may be the ability of the conveyor to operate consistently without unexpected failures or breakdowns, The reliability of the conveyor may be achieved by utilizing an adjustable supporting structure that maintains suitable positioning relative to the raw materials being transported. This structure minimizes the risk of jams and misalignments, ensuring that the conveyor operates smoothly over extended periods.

Efficiency is the ability of the conveyor to maximize throughput while minimizing resource consumption, such as energy and maintenance costs. By ensuring a consistent flow of materials and reducing the likelihood of interruptions, the disclosed system enhances operational efficiency. This minimizes the need for frequent maintenance interventions, allowing for smoother operations and less downtime.

The disclosed system further controls aerial vehicles such as (Unmanned Aerial Vehicles (UAVs)) for making precise adjustments to the raw materials placed on the adjustable supporting structure of the conveyor. By integrating image analysis and real-time visual camera feeds, the disclosed system can accurately identify specific areas on the conveyor that require intervention. This allows for immediate corrective actions to be taken, whether it involves addressing defects in the placement of the raw materials or adjusting the height of the adjustable supporting structure to accommodate varying material sizes and weights. This approach enhances the operational efficiency of the conveyor system and minimizes downtime caused by mechanical failures, ensuring a seamless flow of raw materials throughout the processing line.

The disclosed system utilizes an Artificial Intelligence (AI) model to analyze the data in real-time. The AI model continuously learns from the data in real-time and may be adapted based on the real-time characteristics of the raw materials. This reduces the need for frequent retraining on static datasets, allowing the AI model to become more efficient and responsive to changes in the characteristics of the raw materials. Further, by integrating image analysis and real-time visual feeds, the AI model can be utilized for specific areas of interest (such as identifying an anomaly with an entity or identifying an anomaly with the adjustable supporting structure), optimizing the processing power. Instead of analyzing all the received data equally, the system can prioritize the data that indicates potential issues (e.g., slippage or misalignment), leading to more efficient use of computational resources.

The use of UAVs for making precise adjustments to raw materials allows for greater flexibility and responsiveness of the conveyor. The UAVs can quickly address anomalies that arise on the conveyor, such as misalignment or uneven material distribution, thereby enhancing operational efficiency. Further, the disclosed system can automate the deployment of the UAVs based on the analysis, which reduces the need for manual intervention and ensures that corrective actions are taken instantly. This streamlines the operations of the conveyor and further minimizes the probability of errors during the operation of the conveyor.

In various embodiments of the disclosure, a computer-implemented method for generation of control instructions to control an operation of a conveyor is described. The computer-implemented method includes receiving, by a computer, image data associated with each section of a plurality of sections of a conveyor. Each section of the plurality of sections includes at least one adjustable supporting structure. The conveyor is configured to move a plurality of entities positioned thereon. The computer-implemented method further includes receiving, by the computer, operational data associated with the conveyor. The computer-implemented method further includes applying, by the computer, an artificial intelligence (AI) model on the image data and the operational data. The computer-implemented method further includes determining, by the computer, anomaly data for an anomaly associated with the conveyor. The anomaly data is determined based on the application of the AI model. The anomaly is associated with at least one of a movement of the conveyor, a specific entity of the plurality of entities, or the at least one adjustable supporting structure of a specific section of the plurality of sections. The computer-implemented method further includes generating, by the computer, a set of control instructions based on the anomaly data. The set of control instructions is associated with an operation of the conveyor. The computer-implemented method further includes outputting, by the computer, the set of control instructions.

In various embodiments of the disclosure, the computer-implemented method further includes receiving, by the computer, aerial vehicle data associated with each aerial vehicle of a plurality of aerial vehicles. The computer-implemented method further includes identifying, by the computer, a specific aerial vehicle of the plurality of aerial vehicles for resolving the anomaly. The specific aerial vehicle is identified based on the anomaly data and the aerial vehicle data. The computer-implemented method further includes generating, by the computer, the set of control instructions for the specific aerial vehicle based on the anomaly data and the aerial vehicle data. The computer-implemented method further includes controlling, by the computer, an operation of the specific aerial vehicle based on the set of control instructions.

In various embodiments of the disclosure, the operation of the specific aerial vehicle corresponds to resolving the anomaly. The operation of the specific aerial vehicle includes one of removing the specific entity or changing a position of the specific entity.

In various embodiments of the disclosure, the computer-implemented method further includes determining, by the computer, entity data associated with each entity of the plurality of entities based on the application of the AI model on the image data and the operational data. The computer-implemented method further includes determining, by the computer, the anomaly data based on the entity data.

In various embodiments of the disclosure, the entity data includes at least one of size data associated with each entity of the plurality of entities, weight data associated with the plurality of entities, shape data associated with each entity of the plurality of entities, fragility data associated with each entity of the plurality of entities, and chemical properties associated with each entity of the plurality of entities.

In various embodiments of the disclosure, the computer-implemented method further includes determining, by the computer, height data associated with the at least one adjustable supporting structure of the specific section. The height data is determined based on the application of the AI model on the image data associated with each section of the plurality of sections of the conveyor. The computer-implemented method further includes determining, by the computer, size data associated with at least one entity of the plurality of entities. The at least one entity is associated with the at least one adjustable supporting structure of the specific section. The at least one entity is inclusive of the specific entity. The size data is determined based on entity data. The computer-implemented method further includes generating, by the computer, the set of control instructions based on at least the height data and the size data. The computer-implemented method further includes controlling, by the computer, the at least one adjustable supporting structure to execute an adjustment operation. The adjustment operation is executed to adjust a height of the at least one adjustable supporting structure. The controlling is based on the set of control instructions.

In various embodiments of the disclosure, the computer-implemented method further includes receiving, by the computer, historical operation data associated with a plurality of training conveyors. The plurality of training conveyors is exclusive of the conveyor. The computer-implemented method further includes generating, by the computer, a simulation environment based on the historical operation data, the simulation environment including a virtual conveyor having a plurality of virtual sections. Each virtual section of the plurality of virtual sections includes at least one virtual adjustable supporting structure. The virtual conveyor is configured to move a plurality of virtual entities positioned thereon. The computer-implemented method further includes determining, by the computer, virtual operational data associated with the virtual conveyor. The computer-implemented method further includes training, by the computer, the AI model based on the historical operation data, the simulation environment, and the virtual operational data. The AI model is trained to identify a virtual anomaly associated with the virtual conveyor. The computer-implemented method further includes storing, by the computer, the trained AI model.

In various embodiments of the disclosure, the operational data includes at least one of weight data associated with each section of the plurality of sections, noise data associated with the conveyor, or speed data associated with the conveyor.

In various embodiments of the disclosure, the anomaly data for the anomaly includes at least one of a type associated with the anomaly, a location associated with the anomaly, or a resolution process associated with the anomaly.

In various embodiments of the disclosure, the computer-implemented method further includes controlling, by the computer, an execution of the resolution process at the location associated with the anomaly for resolving the anomaly. The execution of the resolution process is based on the set of control instructions.

In various embodiments of the disclosure, the anomaly is indicative of a deviation from pre-defined operating conditions associated with the at least one of the movement of the conveyor, the specific entity of the plurality of entities, or the at least one adjustable supporting structure of a specific section of the plurality of sections.

In various embodiments of the disclosure, a computer system for generation of control instructions to control an operation of a conveyor is described. The computer system includes a processor set, a computer-readable storage media, and program instructions that are stored on the one or more computer-readable storage media. The program instructions are executable by the processor set to cause the processor set to receive image data associated with each section of a plurality of sections of a conveyor. Each section of the plurality of sections includes at least one adjustable supporting structure. The conveyor is configured to move a plurality of entities positioned thereon. The program instructions further cause the processor set to receive operational data associated with the conveyor. The program instructions further cause the processor set to apply an artificial intelligence (AI) model to the image data and the operational data. The program instructions further cause the processor set to determine anomaly data for an anomaly associated with the conveyor. The anomaly data is determined based on the application of the AI model. The anomaly is associated with at least one of a movement of the conveyor, a specific entity of the plurality of entities, or the at least one adjustable supporting structure of a specific section of the plurality of sections. The program instructions further cause the processor set to generate a set of control instructions based on the anomaly data. The set of control instructions is associated with an operation of at least one of the conveyor or an aerial vehicle. The program instructions further cause the processor set to control the operation of at least one of the conveyor, or the aerial vehicle based on the set of control instructions.

In various embodiments of the disclosure, the program instructions further cause the processor set to receive aerial vehicle data associated with each aerial vehicle of a plurality of aerial vehicles. The program instructions further cause the processor set to identify a specific aerial vehicle of the plurality of aerial vehicles for resolving the anomaly. The specific aerial vehicle is identified based on the anomaly data and the aerial vehicle data. The program instructions further cause the processor set to generate the set of control instructions for the specific aerial vehicle based on the anomaly data and the aerial vehicle data. The program instructions further cause the processor set to control an operation of the specific aerial vehicle based on the set of control instructions.

In various embodiments of the disclosure, the operation of the specific aerial vehicle corresponds to resolving the anomaly. The operation of the specific aerial vehicle includes one of removing the specific entity, or changing a position of the specific entity.

In various embodiments of the disclosure, the program instructions further cause the processor set to determine entity data associated with each entity of the plurality of entities based on the application of the AI model on the image data and the operational data. The program instructions further cause the processor set to determine the anomaly data based on the entity data.

In various embodiments of the disclosure, the entity data includes at least one of size data associated with each entity of the plurality of entities, weight data associated with the plurality of entities, shape data associated with each entity of the plurality of entities, fragility data associated with each entity of the plurality of entities, and chemical properties associated with each entity of the plurality of entities.

In various embodiments of the disclosure, the program instructions further cause the processor set to determine height data associated with the at least one adjustable supporting structure of the specific section. The height data is determined based on the application of the AI model on the image data associated with each section of the plurality of sections of the conveyor. The program instructions further cause the processor set to determine size data associated with at least one entity of the plurality of entities. The at least one entity is associated with the at least one adjustable supporting structure of the specific section. The at least one entity is inclusive of the specific entity. The size data is determined based on entity data. The program instructions further cause the processor set to generate the set of control instructions based on at least the height data and the size data. The program instructions further cause the processor set to control the at least one adjustable supporting structure to execute an adjustment operation. The adjustment operation is executed to adjust the height of the at least one adjustable supporting structure. The control is based on the set of control instructions.

In various embodiments of the disclosure, the program instructions further cause the processor set to receive historical operation data associated with a plurality of training conveyors. The plurality of training conveyors is exclusive of the conveyor. The program instructions further cause the processor set to generate a simulation environment based on the historical operation data, the simulation environment including a virtual conveyor having a plurality of virtual sections. Each virtual section of the plurality of virtual sections includes at least one virtual adjustable supporting structure. The virtual conveyor is configured to move a plurality of virtual entities positioned thereon. The program instructions further cause the processor set to determine virtual operational data associated with the virtual conveyor. The program instructions further cause the processor set to train the AI model based on the historical operation data, the simulation environment, and the virtual operational data. The AI model is trained to identify a virtual anomaly associated with the virtual conveyor. The program instructions further cause the processor set to store the trained AI model.

In various embodiments of the disclosure, the operational data includes at least one of weight data associated with each section of the plurality of sections, noise data associated with the conveyor, or speed data associated with the conveyor.

In various embodiments of the disclosure, a computer program product for the generation of control instructions to control an operation of a conveyor is described. The computer program product includes a computer-readable storage media having program instructions stored on the computer-readable storage media to perform operations. The operations include receiving image data associated with each section of a plurality of sections of the conveyor. Each section of the plurality of sections includes at least one adjustable supporting structure. The conveyor is configured to move a plurality of entities positioned thereon. The operations further include receiving operational data associated with the conveyor. The operations further include applying an artificial intelligence (AI) model to the image data and the operational data. The operations further include determining anomaly data for an anomaly associated with the conveyor. The anomaly data is determined based on the application of the AI model. The anomaly is associated with at least one of a movement of the conveyor, a specific entity of the plurality of entities, or the at least one adjustable supporting structure of a specific section of the plurality of sections. The operations further include generating a set of control instructions based on the anomaly data. The set of control instructions is associated with an operation of the conveyor. The operations further include outputting the set of control instructions.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

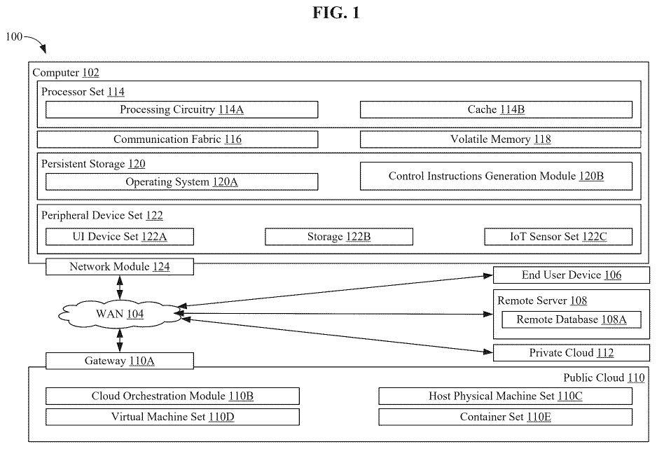

FIG. 1 is a diagram that illustrates a computing environment for the generation of control instructions to control the operation of the conveyor, in accordance with an embodiment of the disclosure. With reference to FIG. 1, there is shown a computing environment 100 that contains an example of an environment for execution of at least some of the computer code/module involved in performing the methods, such as a control instructions generation module 120B. In addition to the control instructions generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the control instructions generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the dynamic modification of the control instructions generation module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the control instructions generation module 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and other sensors may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In an embodiment of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

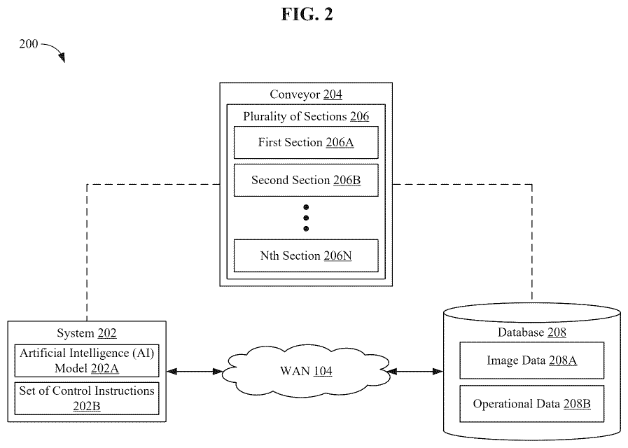

FIG. 2 is a diagram that illustrates an environment for the generation of the control instructions to control the operation of the conveyor, in accordance with an embodiment of the disclosure. FIG. 2 is explained in conjunction with elements from FIG. 1. With reference to FIG. 2, there is shown a diagram of a network environment 200. The network environment 200 includes a system 202, and a conveyor 204. The system 202 further includes an Artificial Intelligence (AI) model 202A. The system 202 is configured to generate a set of control instructions 202B to control the operation of the conveyor 204. The conveyor 204 includes a plurality of sections 206. The plurality of sections 206 further includes a first section 206A, a second section 206B, up to an Nth section 206N. The network environment 200 further includes a database 208. The database 208 is configured to store the image data 208A and operational data 208B. The network environment 200 further includes the WAN 104 of FIG. 1.

The system 202 may include suitable logic, circuitry, interfaces, and/or code that may be configured to receive the image data 208A associated with each section of the plurality of sections 206 of the conveyor 204. Each section of the plurality of sections 206 includes at least one adjustable supporting structure. The conveyor 204 is configured to move the plurality of entities positioned thereon. The system 202 is further configured to receive the operational data 208B associated with the conveyor 204. Further, the system 202 is configured to apply the AI model 202A on the image data 208A and the operational data 208B. The system 202 is further configured to determine anomaly data for the anomaly associated with the conveyor 204. Further, the system 202 is configured to generate the set of control instructions 202B based on the anomaly data. The system 202 is further configured to output the set of control instructions 202B. In an example, the system 202 may be hosted on a server.

In an embodiment, the AI model 202A is a computational process for performing tasks that typically require cognitive abilities. These tasks can include recognizing patterns, making decisions, and predicting outcomes. The AI model 202A is trained on large datasets and uses various processes to learn from the data, thereby improving the performance of the AI model 202A over time. In an embodiment, the system 202 may apply the AI model 202A on the image data 208A and the operational data 208B. The AI model 202A utilizes multiple processes for image data processing. The multiple processes may include, for example, but not limited to, data augmentation, image classification, object detection, semantic segmentation, and image enhancement.

In an embodiment, the conveyor 204 is a mechanical apparatus used to transport materials, products, or goods from a first location to a second location within a facility or production environment such as, but not limited to, manufacturing facilities, warehouses, and distribution centers, food and beverage industries, mining operations, and construction sites. Further, the conveyor 204 includes the plurality of sections 206. Each section of the plurality of sections 206 is a specific segment or zone designed to hold and transport raw materials (such as plurality of entities). Each section may vary in size, shape, and configuration, depending on the type of raw materials being transported and the overall design of the conveyor 204. In an example, each section may be the space between two consecutive adjustable supporting structures. Each section includes at least one adjustable supporting structure. The adjustable supporting structure may be retractable horizontal modules that may be configured to support a plurality of entities within the conveyor 204. The adjustable supporting structure may prevent the plurality of entities from falling off the conveyor 204 while the plurality of entities are being transported from the first location to the second location. The adjustable supporting structure supports a load of entities placed on the conveyor 204 associated with the adjustable supporting structure while providing flexibility to adjust position of the adjustable supporting structure, ensuring a smooth transfer of the plurality of entities (such as the raw materials) from the first location to the second location. In the case of the conveyor 204 corresponding to a vertical conveyor belt, the first location may be lower elevation and the second location may be the higher elevation, or vice versa.

In an embodiment, the database 208 is a structured collection of data that enables efficient storage, retrieval, and management of information, often organized in a way that facilitates easy access and manipulation. The database 208 achieves efficient storage by organizing and indexing data in a logical and systematic manner, allowing for quick retrieval and access to the stored data. In an embodiment, the system 202 may utilize the database 208 to store and manage data associated with the operation and performance of the conveyor 204. By way of example, and not by limitation, the database 208 is configured to store the image data 208A associated with the conveyor 204. The image data 208A may include images of the plurality of entities being transported on the conveyor 204. Further, the image data 208A may include images of each section of the plurality of sections 206 of the conveyor 204. Further, the image data 208A may include images of one or more components associated with the conveyor 204. This image data 208A can be significant for real-time monitoring and analysis, enabling proactive maintenance and optimization of the performance of the conveyor 204. Continuous analysis of the image data 208A allows the system 202 to monitor the condition of the conveyor 204 and the raw materials being transported. This real-time feedback helps to identify potential anomalies before these potential anomalies escalate into significant problems and the operation of the conveyor 204 gets affected.

Additionally, the database 208 is configured to store the operational data 208B. By way of example, and not by limitation, the operational data 208B includes at least one of weight data associated with each section of the plurality of sections 206, noise data associated with the conveyor 204, and speed data associated with the conveyor 204.

In operation, for the generation of control instructions to control the operation of the conveyor 204, the system 202 is configured to receive the image data 208A associated with each section of a plurality of sections 206 of the conveyor 204. Each section of the plurality of sections 206 includes the at least one adjustable supporting structure, which is needed for maintaining the stability and functionality of the conveyor 204. The image data 208A provides a visual representation of the operating condition of the conveyor 204 and the positioning of a plurality of entities that are transported on the conveyor 204. For example, the image data is associated with a plurality of images. Each of the plurality of images may correspond to different sections of the plurality of sections 206 of the conveyor 204. The image data 208A is used for identifying any potential issues that may arise within any specific section of the plurality of sections 206 of the conveyor 204.

Further, the system 202 receives the operational data 208B associated with the conveyor 204. The operational data 208B may include various operational parameters of the conveyor. These operational parameters may include, but are not limited to, weight data associated with each section of the plurality of sections 206, the noise data associated with the conveyor 204, or the speed data associated with the conveyor 204. In an embodiment, the weight data may be indicative of a total weight being carried by the conveyor 204 as well as weight carried by each section of the conveyor 204. In an embodiment, the weight data may correspond to the weight of the plurality of entities placed within each section of the plurality of sections 206 of the conveyor. For example, if there are two boxes of weight 50 Kilograms each placed within the first section 206A of the plurality of sections 206, then the weight data associated with the first section 206A may correspond to 100 Kilograms. Further, the noise data may be indicative of a level of noise, such as in decibels that is generated by the conveyor 204 during the operation (such as transporting the plurality of entities from the first location to the second location). The noise data may indicate mechanical performance and potential malfunctions in the conveyor 204. Anomalies in noise levels may signal the need for maintenance or adjustments to ensure smooth operation. Further, the speed data indicates an operational speed of the conveyor 204, providing insights into efficiency in the movement of the conveyor 204. Variations in the speed of the movement of the conveyor 204 may affect throughput and may require adjustments to optimize performance and prevent bottlenecks. The optimization of performance may correspond to the process of adjusting the speed of the conveyor to achieve high throughput while minimizing delays and ensuring smooth operation. The optimization of the performance of the conveyor 204 may be achieved through continuous monitoring of the conveyor 204 performance, analyzing operational data, and implementing rectification mechanisms that allow for real-time adjustments based on operational fluctuations.

Further, the system 202 applies the AI model 202A to the received image data 208A and the operational data 208B. The AI model 202A is trained to identify anomalies within the conveyor 204. The AI model 202A processes the image data 208A and the operational data 208B to identify any discrepancies within the image data 208A and the operational data 208B that may indicate the anomaly.

Further, the system 202 is configured to determine anomaly data for the anomaly associated with the conveyor 204. The anomaly is indicative of a deviation from pre-defined operating conditions associated with the at least one of the movement of the conveyor 204, the specific entity of the plurality of entities, or the at least one adjustable supporting structure of a specific section of the plurality of sections 206.

In an embodiment, the anomaly may be associated with the movement of the conveyor 204. For example, the movement of the conveyor 204 is slow as compared to the required speed associated with the conveyor or the movement of the conveyor 204 is fast as compared to the required speed associated with the conveyor 204. Further, the anomaly may be associated with a specific entity of the plurality of entities. For example, the first entity that may be placed on the first section 206A may be on the verge of falling off due to misalignment with the adjustable supporting structure associated with the first section 206A. The anomaly may be further associated with at least one supporting structure of a specific section of the plurality of sections 206. For example, the height of the adjustable supporting structure associated with the first section 206A may be less than the height of the specific entity placed within the first section 206A of the conveyor 204. Further, the anomaly data for the anomaly may include, but is not limited to, a type associated with the anomaly, a location associated with the anomaly, and/or a resolution process associated with the anomaly.

In an embodiment, the type of the anomaly categorizes a nature of the anomaly that occurred during the operation of the conveyor 204. For example, the type of the anomaly may be, such as mechanical failure, misalignment between a specific entity and the specific adjustable supporting structure, or operational inefficiency of the conveyor 204. Further, the location associated with the anomaly indicates, for example, the specific section of the conveyor 204 in which the anomaly persists or the adjustable supporting structure where the anomaly is identified. Accurate location information results in quickly addressing the issue, minimizing downtime, and ensuring efficient maintenance operations. Further, the resolution process associated with the anomaly is indicative of the steps required to rectify the identified anomaly. The accurate location information about where the anomaly persists enables efficient maintenance operations by enabling targeted and swift intervention, allowing for quick identification and resolution of the anomaly, thereby reducing downtime and increasing overall productivity of the conveyor 204.

In an embodiment, the system 202 is configured to generate the set of control instructions 202B based on the determined anomaly data. The set of control instructions 202B is generated to rectify the identified anomaly. The set of control instructions 202B is executable for controlling the operation of the conveyor 204 or the adjustable supporting structure of the specific section where the anomaly is identified. For example, if an anomaly related to the speed of the conveyor 204 is identified, the set of control instructions 202B may include instructions to adjust motor settings associated with the conveyor 204. Further, once the set of control instructions 202B is generated, the set of control instructions 202B is outputted for implementation.

In an embodiment, the system 202 implements the set of control instructions 202B to resolve the identified anomaly. In an alternate embodiment, the system 202 controls one or more robots to resolve the identified anomaly based on the set of control instructions 202B. The system 202 may transmit the set of control instructions 202B to at least one robot of the one or more robots via a network (such as the WAN 104). Subsequently, the at least one robot may implement the set of control instructions 202B and address the identified anomaly efficiently. The system 202 resolves the identified anomaly by automating the resolution process through the use of the one or more robots, that may accurately implement the set of control instructions 202B, thereby eliminating manual intervention and minimizing the time required to address the anomaly. Examples of the at least one robot that may be utilized by the system 202 to resolve the identified anomaly may include, but are not limited to, an inspection robot, a pick and place robot, a mobile robot, a service robot, or a robotic arm.

In an alternate embodiment, the system 202 may be configured to transmit the set of control instructions 202B to an aerial vehicle. In a scenario, the aerial vehicle corresponds to a drone. The drone is specifically a type of unmanned aerial vehicle (UAV) designed to operate without a human pilot on board. The system 202 may transmit the set of control instructions 202B to the aerial vehicle, and the aerial vehicle may implement the set of control instructions to address the identified anomaly. For example, the system 202 identifies the anomaly associated with the specific entity placed within the first section 206A, where the specific entity is placed incorrectly within the first section 206A and may fall off. The system 202 may generate the set of control instructions 202B to address the anomaly and transmit the generated set of control instructions 202B to the aerial vehicle. The aerial vehicle may implement the set of control instructions 202B to resolve the identified anomaly.

Although in FIG. 1, the system 202 is associated with the conveyor 204, the disclosure is not so limited. Accordingly, in some embodiments, the system 202 may be an entity that may be associated with a controller associated with the conveyor 204, without deviation from the scope of the disclosure.

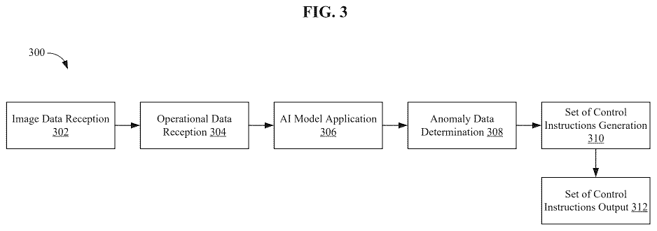

FIG. 3 is a diagram 300 that illustrates one or more operations performed by the system 202 for the generation of the control instructions to control the operation of the conveyor 204, in accordance with an embodiment of the disclosure. FIG. 3 is explained in conjunction with elements from FIG. 1, and FIG. 2. With reference to FIG. 3, the operations may start at 302.

At 302, an image data reception operation is executed. In the image data reception operation, the system 202 is configured to receive the image data 208A associated with each section of the plurality of sections 206 of the conveyor 204. Each section of the plurality of sections 206 includes the at least one adjustable supporting structure. Further, the conveyor 204 is configured to move a plurality of entities positioned thereon.

By way of example, and not by limitation, the system 202 receives the image data 208A from the database 208. The image data 208A is associated with each section of the plurality of sections 206. In an example, each section of the plurality of sections 206 associated with the conveyor 204 may be referred to as a bucket or a pocket. In an embodiment, each section of the plurality of sections 206 is integrated with one or more sensors. Moreover, one or more image sensors, such as cameras may be positioned to capture a plurality of images of the conveyor 204. In an example, the system 202 is configured to control the one or more image sensors to take images of each section of the plurality of sections 206. Further, the images taken by the one or more image sensors may be transmitted to the database 208 and are stored therein as the image data 208A. In certain cases, the images taken by the one or more image sensors may be transmitted to the system 202 as the image data 208A. The image data reception operation enhances monitoring and adaptability of the conveyor 204 which includes the plurality of sections 206, and each section is equipped with the adjustable supporting structures. The one or more image sensors may be high-resolution cameras positioned above the conveyor 204 or alongside each section of the conveyor 204 to capture the image data 208A in real-time. The image data 208A includes visual information about each entity of the plurality of entities on the conveyor 204.

At 304, an operational data reception operation is executed. In the operational data reception operation, the system 202 is configured to receive the operational data 208B associated with the conveyor 204. By way of example, and not by limitation, the conveyor 204 may correspond to the vertical conveyor that may be utilized to facilitate the movement of the plurality of entities placed within the plurality of sections 206. Each section of the plurality of sections 206 may be equipped with advanced sensors and data transmission capabilities that enable the system 202 to execute a real-time operational data reception operation. As the plurality of entities is loaded onto the conveyor 204 at the first location, the system 202 may start to receive the operational data 208B. The operational data 208B includes weight measurements for each section of the plurality of sections 206.

Further, the one or more sensors associated with the conveyor 204 are configured to continuously capture the noise data associated with the conveyor 204. An unusual increase in noise levels may indicate mechanical wear or misalignment within the conveyor 204. Further, the one or more sensors are configured to monitor the speed data to ensure adequate operational efficiency. In an embodiment, the system 202 is configured to receive the operational data 208B from the database 208. In an alternate embodiment, the system 202 is configured to receive, in real-time, the operational data 208B from the one or more sensors integrated with the conveyor 204.

At 306, an AI model application operation is executed. In the AI model application operation, the system 202 is configured to apply the AI model 202A on the image data 208A and the operational data 208B. By way of example, and not by limitation, the system 202 is configured to apply the AI model 202A on the received image data 208A and the received operational data 208B. As the plurality of sections 206 moves through the conveyor 204, the one or more sensors such as high-resolution cameras capture real-time images of each section of the plurality of sections 206 (such as the first section 206A, the second section 206B, up to the Nth section 206N). The AI model 202A analyzes the plurality of images associated with the conveyor 204 to identify an anomaly within the conveyor 204. The anomaly may be associated with for example, a damage in a specific entity of the plurality of entities, misalignment of the specific entity on the conveyor 204, the weight associated with a specific section being greater than a weight threshold of that corresponding section, or improper height of an adjustable supporting structure associated with the specific entity. In an embodiment, the weight threshold associated with the specific section may correspond to the total weight that the specific section may carry. If the weight greater than the weight threshold is exerted on the specific section, this may cause wear and tear within the specific section.

Further, the system 202 is configured to utilize the AI model 202A to process the operational data 208B, which includes the weight data associated with each section of the plurality of sections 206, the speed data associated with the conveyor 204, and the noise data associated with the conveyor 204. For example, if the system 202 identifies based on the analysis of the operational data 208B that the first section 206A is unusually heavy and the conveyor 204 is generating excess noise, such as greater than a noise threshold, then the system 202 may identify the anomaly in the first section 206A.

At 308, an anomaly data determination operation is executed. In the anomaly data determination operation, the system 202 is configured to determine the anomaly data for the anomaly associated with the conveyor 204. The anomaly data is determined based on the application of the AI model 202A at 306. In an example, the anomaly is associated with the movement of the conveyor 204, the specific entity of the plurality of entities, or the adjustable supporting structure of the specific entity of a specific section of the plurality of sections 206.

By way of example, and not by limitation, the system 202 evaluates a variety of factors, including the movement patterns of the conveyor 204, each entity of the plurality of entities, and stability and height of the adjustable supporting structure associated with the specific section in which the specific entity is positioned or placed. By analyzing this information, the system 202 is configured to identify the anomaly that may affect the operation of the conveyor 204, such as unexpected jolts in movement or structural misalignments.

Further, the anomaly data associated with the anomaly provides a detailed overview of the identified anomaly. The detailed overview of the identified anomaly may include such as the type of anomaly detected, its exact location within the conveyor 204, or recommended resolution processes. For example, if the AI model 202A determines the anomaly in the movement of the conveyor 204 characterized by an abrupt halt in the operation of the conveyor 204, the anomaly data will specify this as a movement-related anomaly, identify the specific section of the conveyor 204 where the anomaly has occurred, and suggest the resolution process to rectify the anomaly, such as inspecting the drive mechanism or adjusting the tension on a conveyor belt.

At 310, a set of control instructions generation operation is executed. In the set of control instructions generation, the system 202 is configured to generate the set of control instructions 202B based on the anomaly data. The set of control instructions 202B is associated with the operation of the conveyor 204. By way of example, and not by limitation, the system 202 executes the set of control instructions to enhance the operational efficiency of the conveyor 204. By utilizing the determined anomaly data, the system 202 is configured to generate the set of control instructions 202B. The set of control instructions 202B instructions are generated to address the anomaly identified in the anomaly data determination operation at 308, ensuring that the conveyor 204 operates smoothly and safely. For example, if the anomaly data indicates a misalignment in one of the adjustable supporting structures, the system 202 generates the set of control instructions 202B to recalibrate the adjustable supporting structure, thereby restoring adequate alignment and stability.

In an example, the height of the adjustable supporting structure associated with the first section 206A of the plurality of sections 206 is 50 cm, and the first entity that is placed within the first section 206A (such as a rectangular block) has a height of 100 cm. The system 202 determines that the height of the adjustable supporting structure associated with the first section 206A is lesser than the height of the first entity placed within the first section 206A. This may indicate that the first entity may fall off the first section 206A due to the height of the first entity being greater than the height of the adjustable supporting structure of the first section 206A. Further, the system 202 generates the set of control instructions 202B corresponding to the increase in height of the adjustable supporting structure associated with the first section 206A.

At 312, a set of control instructions output operation is executed. In the set of control instructions output operation, the system 202 is configured to output the set of control instructions 202B. In an embodiment, the system 202 outputs the generated set of control instructions 202B to a controller of the conveyor 204. In an example, the controller of the conveyor 204 may be utilized to manage an operation of the conveyor 204 ensuring efficient and safe functionality of the conveyor 204. The controller enables direct and automated control of the operation of the conveyor 204 ensuring efficiency. In an embodiment, the controller may execute each control instruction of the set of control instructions 202B to rectify the identified anomaly. In an alternate embodiment, the system 202 may render the generated set of control instructions 202B on a display associated with the controller of the conveyor 204. A user associated with the conveyor 204 may execute the set of control instructions 202B to rectify the identified anomaly. In an alternate embodiment, the system 202 outputs the generated set of control instructions 202B to the aerial vehicle. In an embodiment, the aerial vehicle corresponds to the UAV.

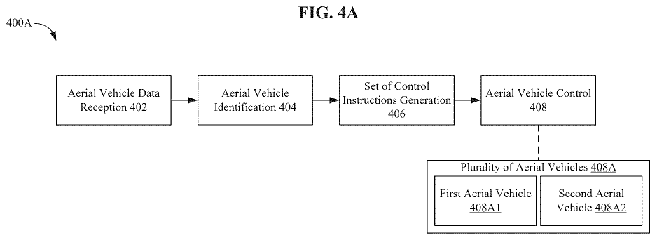

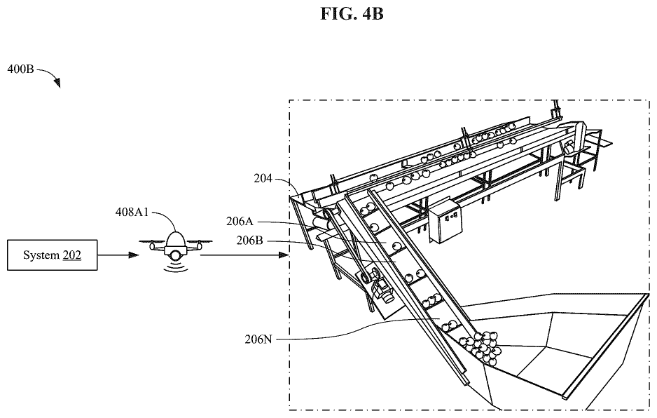

FIG. 4A is a diagram 400A that illustrates one or more operations performed by the system 202 for controlling an operation of a specific aerial vehicle based on the set of control instructions 202B, in accordance with an embodiment of the disclosure. FIG. 4A is explained in conjunction with elements from FIG. 1, FIG. 2, and FIG. 3. With reference to FIG. 4A, the operations may start at 402.

At 402, an aerial vehicle data reception operation is executed. In the aerial vehicle data reception operation, the system 202 is configured to receive aerial vehicle data associated with each aerial vehicle of a plurality of aerial vehicles. By way of example, and not by limitation, the system 202 is configured to gather and process real-time data associated with the plurality of aerial vehicles. Each aerial vehicle of the plurality of aerial vehicles may be equipped with advanced sensors and communication technologies that transmit information such as altitude, speed, location, and operational status to the system 202.

In an embodiment, the aerial vehicle data may include, for example, but not limited to, payload capacity associated with each aerial vehicle of the plurality of aerial vehicles, thrust-to-weight ratio of each aerial vehicle of the plurality of aerial vehicles, hovering thrust of each aerial vehicle of the plurality of aerial vehicles, environmental factors (such as altitude, temperature, and wind impact) associated with each aerial vehicle of the plurality of aerial vehicles, location information associated with each aerial vehicle, charging information associated with each aerial vehicle, historical task information associated with each aerial vehicle.

In an example, the plurality of aerial vehicles includes a first aerial vehicle and a second aerial vehicle. The system 202 is configured to determine the aerial vehicle data associated with the first aerial vehicle and the second aerial vehicle. In an embodiment, the first aerial vehicle corresponds to a multirotor drone. The payload capacity associated with the first aerial vehicle is 6 Kg, the thrust-to-weight ratio associated with the first aerial vehicle corresponds to 2:1, the hovering thrust required to maintain a stable hover corresponds to 6 Kg, and the environmental factors associated with the first aerial vehicle may indicate decrease in performance at higher altitude, decrease in thrust output in higher temperature, decrease in stability and control of the first aerial vehicle during flight in strong wind speed, the charging information associated with the first aerial vehicle may indicate that the first aerial vehicle takes for example 2 hours to charge from 0% to 80% and 0% to 100% in 3 hours. The historical task information associated with the first aerial vehicle indicates that the first aerial vehicle has no pending tasks and all the historical tasks have been performed with 100% accuracy.

Further, the second aerial vehicle of the plurality of aerial vehicles corresponds to a fixed-wing Unmanned Aerial Vehicle (UAV). The payload capacity associated with the second aerial vehicle is 4.5 Kg, the thrust-to-weight ratio associated with the first aerial vehicle corresponds to 0.5:1, the hovering thrust is not applicable for the second aerial vehicle as the second aerial vehicle may not be configured to hover, and the environmental factors associated with the second aerial vehicle may indicate decrease in the performance at the higher altitude, decrease in thrust output in higher temperature, and decrease in stability and control of the second aerial vehicle during flight in strong wind speed. The charging information associated with the second aerial vehicle may indicate that the second aerial vehicle takes for example 3 hours to charge from 0% to 80% and 0% to 100% in 4 hours. The historical task information associated with the second aerial vehicle indicates that the second aerial vehicle has no pending tasks and all the historical tasks have been performed with 80% accuracy.

At 404, an aerial vehicle identification operation is executed. In the aerial vehicle identification operation, the system 202 is configured to identify the specific aerial vehicle of the plurality of aerial vehicles for resolving the anomaly. The specific aerial vehicle is identified based on the anomaly data and the aerial vehicle data.

By way of example, and not by limitation, the system 202 identifies the specific aerial vehicle for resolving the anomaly associated with the conveyor 204. In an example, the system 202 determines anomaly data associated with the anomaly using the image data 208A and the operational data 208B. The anomaly data indicates the type of anomaly, the location of the anomaly, and the resolution process of the anomaly. Based on the determined anomaly data, the system 202 identifies the specific section where the anomaly has occurred. For example, the anomaly occurred in the first section 206A of the plurality of sections 206 of the conveyor 204. Further, the system 202 identifies the specific aerial vehicle to resolve the anomaly based on the anomaly data. In an example, the type of anomaly indicates that the entity placed within the first section 206A is placed incorrectly within the first section 206A. The system 202 determines that the weight associated with the first section 206A is 5 Kg. By determining the weight associated with the first section 206A, the system 202 determines that the weight of the entity placed in the first section 206A may be approximately 5 Kg. Further, from the anomaly data, the system 202 determines the resolution process for resolving the anomaly. The system 202 determines that the resolution process corresponds to lifting the entity placed in the first section 206A and placing the entity in the second section 206B the conveyor 204. As described above, the system 202 determined using the received aerial vehicle data that the first aerial vehicle has a payload capacity of 6 Kg and the second aerial vehicle has a payload capacity of 4.5 Kg. Subsequently, the system 202 may identify that the first aerial vehicle is suitable for lifting the entity placed in the first section 206A and placing it in the second section 206B.

At 406, a set of control instructions generation operation is executed. In the set of control instructions generation operation, the system 202 is configured to generate the set of control instructions 202B for the specific aerial vehicle based on the anomaly data and the aerial vehicle data. By way of example, and not by limitation, the system 202 analyses the anomaly data and the aerial vehicle data. As described at 404, the system 202 identified that the first aerial vehicle of the plurality of aerial vehicles is suitable for resolving the anomaly. Further, once the system 202 identifies the specific aerial vehicle (such as the first aerial vehicle), the system generates the set of control instructions 202B to resolve the anomaly. In this case, the set of control instructions 202B is generated for the first aerial vehicle. For example, a first control instruction of the set of control instructions 202B may correspond to turning on the first aerial vehicle, a second control instruction of the set of control instructions 202B may correspond to flying the first aerial vehicle from an aerial vehicle docking station to the identified location of the anomaly (such as the first section 206A), a third control instruction of the set of control instructions 202B may correspond to picking up the entity that is placed within the first section 206A, a fourth control instruction of the set of control instructions 202B may correspond to traveling from the first section 206A to the second section 206B, a fifth control instruction of the set of control instructions 202B may correspond to placing the entity on the second section 206B, and a sixth control instruction of the set of control instructions 202B may correspond to flying back to the aerial vehicle docking station.

At 408, an aerial vehicle control operation is executed. In the aerial vehicle control operation, the system 202 is configured to control an operation of the specific aerial vehicle based on the set of control instructions 202B. In an embodiment, the operation of the specific aerial vehicle may include removing the specific entity or changing a position of the specific entity. By way of example, and not by limitation, the system 202 controls the identified specific aerial vehicle, e.g., the first aerial vehicle. In an example, the identified aerial vehicle corresponds to the first aerial vehicle 408A1 of the plurality of aerial vehicles 408A. Further, the system 202 controls the operation of the first aerial vehicle 408A1. The operations are controlled based on the generated set of control instructions 202B described at 406. In an example, the operation corresponds to changing the position of the specific entity (the entity placed within the first section 206A of the plurality of sections 206) from the first section 206A to the second section 206B. To execute the operation, the system generates the set of control instructions 202B. Further, the system 202 controls the execution of each control instruction of the set of control instructions 202B for successful execution of the operation (changing the position of the specific entity).

For example, the system 202 controls the first aerial vehicle 408A1 to execute the first control instruction that may correspond to turning on the first aerial vehicle 408A1. Further, the system 202 controls the first aerial vehicle 408A1 to execute the second control instruction that may correspond to flying from the aerial vehicle docking station to the identified location of the anomaly (such as the first section 206A). Further, the system 202 controls the first aerial vehicle 408A1 to execute the third control instruction that may correspond to picking up the entity that is placed within the first section 206A. Further, the system 202 controls the first aerial vehicle 408A1 to execute the fourth control instruction that may correspond to traveling from the first section 206A to the second section 206B. Further, the system 202 controls the first aerial vehicle 408A1 to execute the fifth control instruction that may correspond to placing the entity on the second section 206B. Further, the system 202 controls the first aerial vehicle 408A1 to execute the sixth control instruction that may correspond to flying back to the aerial vehicle docking station. Similarly, the system 202 may control the operation of the second aerial vehicle 408A2, if the identified aerial vehicle corresponds to the second aerial vehicle 408A2.

Although the present example describes removing the entity from the first section 206A and placing it in the second section 206B, in certain cases, the anomaly may be resolved in alternate ways. For example, a similar anomaly may be resolved by re-positioning the entity in the first section 206A. In particular, the AI model 202A may analyze possible resolution processes to resolve the anomaly and identify an adequate resolution process. Based on the adequate resolution process, the set of control instructions 202B is generated to control the specific aerial vehicle.

FIG. 4B is a diagram 400B that illustrates an exemplary scenario for controlling an operation of the first aerial vehicle 408A1 based on the set of control instructions 202B, in accordance with an embodiment of the disclosure. FIG. 4B is explained in conjunction with elements from FIG. 1, FIG. 2, FIG. 3, and FIG. 4A.

As shown in FIG. 4B, the system 202 is configured to control the operation of the first aerial vehicle 408A1. FIG. 4B further includes the conveyor 204. The conveyor 204 further includes the plurality of sections 206 (such as the first section 206A, the second section 206B, up to the Nth section 206N). Further, as shown in FIG. 4B the first section 206A includes one entity. The second section 206B includes two entities, and the Nth section 206N includes two entities.

Further, once the system 202 applies the AI model 202A on the received image data 208A and the operational data 208B, the system 202 determines that one of the two entities that are placed on the second section 206B may fall off. Further, to rectify this anomaly, the system 202 may generate the set of control instructions for the first aerial vehicle 408A1. The first instruction of the set of control instructions 202B may correspond to picking up the one of two entities from the second section 206B and the second instruction of the set of control instructions 202B may correspond to placing that entity within the first section 206A.

Further, once the system 202 generates the set of control instructions, the system controls the first aerial vehicle 408A1 to execute each control instruction of the set of control instructions to execute the operation. The successful execution of the operation results in the resolution of the anomaly.

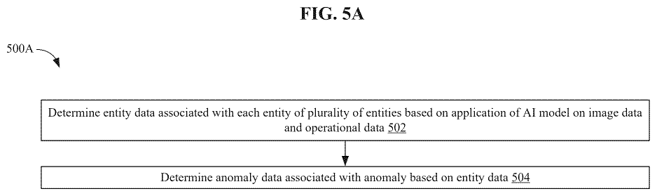

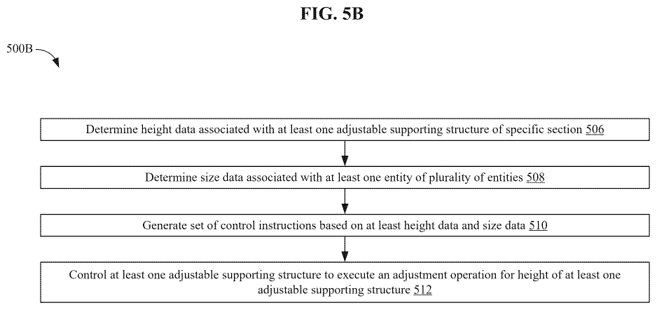

FIG. 5A is a diagram 500A that illustrates a method flowchart for the generation of anomaly data based on entity data, in accordance with an embodiment of the disclosure. FIG. 5A is explained in conjunction with elements from FIG. 1, FIG. 2, FIG. 3, FIG. 4A, and FIG. 4B. The operations of the exemplary method may be executed by any computing system, for example, by the computer 102 of FIG. 1 or the system 202 of FIG. 2. The operations of the flowchart 500A may start at 502.

At 502, entity data associated with each entity of the plurality of entities is determined. In an example, the system 202 is configured to determine entity data associated with each entity of the plurality of entities. The entity data is determined based on the application of the AI model 202A on the image data 208A and the operational data 208B. In an embodiment, the entity data includes at least one of size data associated with each entity of the plurality of entities, weight data associated with the plurality of entities, shape data associated with each entity of the plurality of entities, fragility data associated with each entity of the plurality of entities, and chemical properties associated with each entity of the plurality of entities.

By way of example, and not by limitation, the size data associated with each entity of the plurality of entities may correspond to the size of the respective entity of the plurality of entities. For example, a first entity of the plurality of entities corresponds to a block placed on the first section 206A of the plurality of sections 206 of the conveyor 204. The size data associated with the first entity (the block) is indicative of dimensions of the block. In a scenario, the size data associated with the block placed on the first section 206A indicates that the dimensions of the block correspond to a length*breadth*height of the block (say 50 centimeters (cm)*30 centimeters (cm)* 40 centimeters (cm)). Similarly, the system 202 may determine the size data associated with each entity of the plurality of entities placed on each section of the plurality of sections 206 of the conveyor 204.

By way of example, and not by limitation, the weight data associated with the plurality of entities may correspond to the weight of the plurality of entities. For example, the first entity of the plurality of entities corresponds to a block placed in the first section 206A of the plurality of sections 206 of the conveyor 204. The weight data corresponds to weight exerted on the first section 206A by the plurality of entities placed on the first section 206A. The weight data associated with the first entity (the block) is indicative of the weight of the block. In a scenario, the weight data associated with the block placed on the first section 206A indicates that the weight of the block corresponds to 50 Kilograms (Kg). Similarly, the system 202 may determine the weight data associated with the plurality of entities placed on each section of the plurality of sections 206 of the conveyor 204. In an embodiment, each section of the plurality of sections 206 may be integrated with a weight sensor that may measure the weight that is being exerted on the respective section of the plurality of sections. The weight data associated with each section of the plurality of sections 206 is included within the operational data 208B that the system 202 receives from the database 208. Further, upon the application of the AI model 202A on the operational data 208B, the system 202 determines the weight data associated with the plurality of entities.

By way of example, and not by limitation, the shape data associated with each entity of the plurality of entities correspond to the shape of the respective entity. For example, the first entity of the plurality of entities corresponds to a block placed within the first section 206A of the plurality of sections 206 of the conveyor 204. The shape data associated with the first entity (the block) is indicative of the shape of the block. In a scenario, the shape data associated with the block placed within the first section 206A indicates that the shape of the block corresponds to a rectangular shape. Similarly, the system 202 may determine the shape data associated with each entity of the plurality of entities placed within each section of the plurality of sections 206 of the conveyor 204. In an embodiment, the system 202 applies the AI model 202A on the image data 208A to determine the shape data associated with each entity of the plurality of entities.

By way of example, and not by limitation, the fragility data associated with each entity of the plurality of entities correspond to fragility of the respective entity. For example, the first entity of the plurality of entities corresponds to glass bottles placed within the first section 206A of the plurality of sections 206 of the conveyor 204. The fragility data associated with the first entity (the block) is indicative of at least one of a material composition such as specific type of glass used (e.g., soda-lime glass, borosilicate glass) in the glass bottles, mechanical properties indicative of a tensile strength, a compressive strength, and an elastic modulus the glass bottles, and thermal properties of the glass bottles indicative of information on thermal shock resistance indicating how well the glass of the glass bottles can withstand sudden temperature changes. Similarly, the system 202 may determine the fragility data associated with each entity of the plurality of entities placed within each section of the plurality of sections 206 of the conveyor 204. In an embodiment, the system 202 applies the AI model 202A on the image data 208A to determine the fragility data associated with each entity of the plurality of entities.

By way of example, and not by limitation, the chemical properties associated with each entity of the plurality of entities correspond to chemical composition of the respective entity. For example, the first entity of the plurality of entities corresponds to polyethylene (PE). The system 202 applies the AI model 202A on the image data 208A to determine the chemical properties associated with the first entity (such as polyethylene). Similarly, the system 202 determines the chemical properties of each entity of the plurality of entities placed within each section of the plurality of sections.

At 504, anomaly data associated with an anomaly is determined. In an example, the system 202 is configured to determine the anomaly data associated with the anomaly. In an embodiment, the anomaly data is determined based on the entity data. In a scenario, the conveyor 204 includes the plurality of sections 206, where the plurality of sections includes the first section 206A and the second section 206B. Further, the first entity is placed within the first section 206A of the conveyor 204 and a second entity is placed within the second section 206B of the conveyor 204. In an example, the first entity corresponds to a first block and the second entity corresponds to a second block.

Further, the conveyor 204 (such as the vertical conveyor) is transporting the first block and the second block from a first location to a second location. The system 202 is configured to monitor the operation of the conveyor 204 in real-time. The system 202 is configured to receive image data 208A associated with the first section 206A and the second section 206B of the conveyor 204. Further, the system 202 is configured to receive the operational data 208B associated with the conveyor 204. Hereafter, the system 202 applies the AI model 202A on the received image data 208A and the operational data 208B. In a scenario, upon the application of the AI model 202A on the image data and the operational data 208B, the system 202 determines that the first entity placed within the first section 206A corresponds to the first block and the second section 206B placed within the second section corresponds to the second block. Further, the system 202 determines the entity data associated with the first block and the second block. Further, based on the entity data, the system 202 determines that there exists an anomaly associated with the second block placed within the second section 206B of the conveyor 204.

FIG. 5B is a diagram 500B that illustrates a method flowchart for the generation of the set of control instructions based on height data and size data, in accordance with an embodiment of the disclosure. FIG. 5B is explained in conjunction with elements from FIG. 1, FIG. 2, FIG. 3, FIG. 4A, FIG. 4B and FIG. 5A. The operations of the exemplary method may be executed by any computing system, for example, by the computer 102 of FIG. 1 or the system 202 of FIG. 2. The operations of the flowchart 500B may start at 506.

At 506, height data associated with at least one adjustable supporting structure of a specific section of the conveyor 204 is determined. In an example, the system 202 is configured to determine height data associated with the at least one adjustable supporting structure of the specific section. The height data is determined based on the application of the AI model 202A on the image data 208A associated with each section of the plurality of sections 206 of the conveyor 204. In an alternate embodiment, the height data may be determined by the controller of the conveyor 204.

By way of example, and not by limitation, the adjustable supporting structure consists of two ends such as a first end and a second end. The first end may be in contact with the surface of the conveyor 204. The adjustable supporting structure may be extended upwards from the surface of the conveyor 204 at an angle of, for example, 90 degrees. The second end of the adjustable supporting structure may correspond to an edge of the upward-extended adjustable supporting structure. In an embodiment, the height data may correspond to the distance between the first end and the second end. For example, the two consecutive adjustable supporting structures may make up the specific section of the plurality of sections 206 of the conveyor 204. In a scenario, the first section 206A and the second section 206B are adjacent to each other. Further, the first section 206A includes a first adjustable supporting structure and the second section 206B includes a second adjustable supporting structure. In an embodiment, the system 202 determines that the height data associated with the first adjustable supporting structure corresponds to 40 cm, and the height data associated with the second adjustable supporting structure corresponds to 100 cm. Similarly, the system 202 determines height data for each adjustable supporting structure associated with the conveyor 204.

At 508, size data associated with at least one entity of the plurality of entities is determined. In an example, the system 202 is configured to determine the size data associated with at least one entity of the plurality of entities. The at least one entity is associated with the at least one adjustable supporting structure of the specific section. Further, the size data is determined based on the entity data. In an example, the size data associated with at least one entity of the plurality of entities may be identified as part of the entity data associated with each of the plurality of entities.

By way of example, and not by limitation, the conveyor 204 includes the first section 206A and the second section 206B. Further, the first section 206A is associated with the first adjustable supporting structure, and the second section 206B is associated with the second adjustable supporting structure. In an example, the first entity (a rectangular block) is placed within the first section 206A, and the second entity (a square block) is placed within the second section 206B. Based on the entity data, the system 202 determines the size data associated with the first entity and the second entity. The system 202 determines from the size data associated with the first entity that the height of the first entity corresponds to 80 cm. Similarly, the system 202 determines from the size data associated with the second entity that the height of the second entity corresponds to 30 cm.

At 510, the set of control instructions 202B is generated based on the height data and the size data. In an example, the system 202 is configured to generate the set of control instructions 202B based on the height data and the size data. In an embodiment, the set of control instructions 202B causes an execution of an adjustment operation for the height of the at least one adjustable supporting structure.

By way of example, and not by limitation, the system 202 is configured to generate the set of control instruction 202B to cause the execution of the adjustment operation of the height of the adjustable supporting structure. As described at 508, the system 202 determines from the size data associated with the first entity that the height of the first entity corresponds to 80 cm. Similarly, the system 202 determines from the size data associated with the second entity that the height of the second entity corresponds to 30 cm. Further, the system 202 determines that the height data associated with the first adjustable supporting structure corresponds to 40 cm, and height data associated with the second adjustable supporting structure corresponds to 100 cm. In this case, the system 202 determines that the height of the first entity placed within the first section 206A is greater than the height of the first adjustable supporting structure associated with the first section 206A. This height difference may cause the first entity to fall off the first section 206A. Further, to resolve this anomaly, the system 202 generates the set of control instructions 202B corresponding to increase in height of the first adjustable supporting structure associated with the first section 206A.

In an embodiment, the system 202 may transmit the generated set of control instructions 202B to the controller of the conveyor 204. In an alternate embodiment, the system 202 may render the generated set of control instructions 202B on a display associated with the conveyor 204. For example, an operator of the conveyor 204 may execute the set of control operations for resolving the anomaly and enabling error-free operation of the conveyor 204.

At 512, the at least one adjustable supporting structure is controlled to execute an adjustment operation. In an example, the system 202 is configured to control the at least one adjustable supporting structure to execute the adjustment operation. The adjustment operation is executed for adjusting the height of the at least one adjustable supporting structure. The control is based on the set of control instructions 202B.

In an example, if the system 202 determines that the size of the specific entity placed on the first adjustable supporting structure is greater than the height of the first adjustable supporting structure, then the system 202 generates the set of control instructions 202B that corresponds to adjusting the height of the first adjustable supporting structure. The system 202 may control the first adjustable supporting structure to perform the adjustment operation based on the generated set of control instructions 202B.

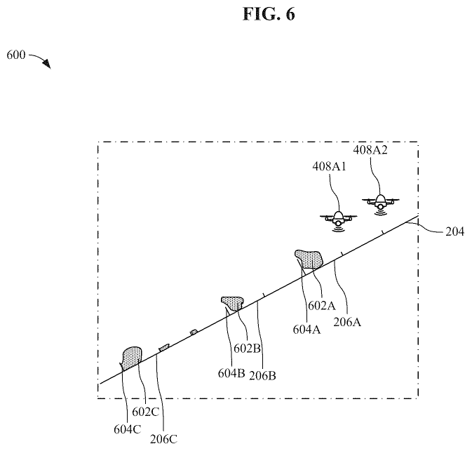

FIG. 6 is a diagram 600 that illustrates an exemplary scenario for generating the set of control instructions 202B for performing the adjustment operation, in accordance with an embodiment of the disclosure. FIG. 6 is explained in conjunction with elements from FIG. 1, FIG. 2, FIG. 3, FIG. 4A, FIG. 4B, FIG. 5A, and FIG. 5B.

As shown in FIG. 6, the conveyor 204 includes a first entity 602A, a second entity 602B, and a third entity 602C. In an embodiment, the first entity 602A is supported by a first adjustable supporting structure 604A, the second entity 602B is supported by a second adjustable supporting structure 604B, and the third entity 602C is supported by a third adjustable supporting structure 604C. In an embodiment, the system 202 receives the image data 208A and the operational data 208B. Further, the system 202 applies the AI model 202A on the received image data 208A and the operational data 208B.

Further, based on the application of the AI model 202A, the system 202 determines size data associated with the first entity 602A. For example, the size data may indicate the dimensions of the first entity 602A. In an example, based on the application of the AI model 202A, the system 202 determines that a size, such as a height, of the first entity 602A is greater than a current height of the first adjustable supporting structure 604A. For example, due to the difference in the height of the first entity 602A and the current height of the first adjustable supporting structure 604A, there may be a possibility of free fall of the first entity 602A, specifically, when the conveyor 204 is a vertical conveyor. Subsequently, this difference in heights may be identified as an anomaly. In an example, the system 202 generates the set of control instructions 202B to cause an execution of the adjustment operation for the current height of the first adjustable supporting structure 604A to resolve the anomaly. The execution of the set of control instructions 202B may cause an increase in the height of the first adjustable supporting structure 604A. Subsequently, an updated height of the first adjustable supporting structure 604A is able to support the size of the first entity 602A. In an alternate example, the system 202 generates the set of control instructions 202B to cause a specific aerial vehicle of the plurality of aerial vehicles 408A to lift and move the first entity 602A from its current section, say the first section 206A, to another section, such as the second section 206B or the third section 206C.

In an example, if the system 202 determines that there is wear and tear in the first adjustable supporting structure 604A, then the system 202 may determine by analyzing the image data 208A, at least one adjustable supporting structure that may be vacant and may be utilized to place the first entity 602A. For example, the system 202 determines that the second adjustable supporting structure 604B is vacant, then based on the determination, the system 202 identifies the specific aerial vehicle to lift the specific entity (say the first entity 602A) and places it on the second adjustable supporting structure 604B.

Further, there is shown the first aerial vehicle 408A1 and the second aerial vehicle 408A2. In an embodiment, the system identifies that the second aerial vehicle is suitable for performing the operation corresponding to changing the position of the second entity 602B. In an example, the second entity 602B was placed on the first adjustable supporting structure at a first time period. The system 202 generates the set of control instructions 202B for the second aerial vehicle 408A2, where the set of control instructions 202B corresponds to lifting the second entity 602B from the first adjustable supporting structure 604A and placing the second entity 602B on the second adjustable supporting structure 604B.

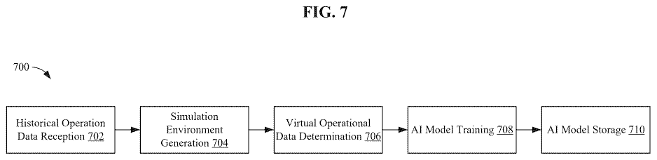

FIG. 7 is a diagram 700 that illustrates one or more operations for training the AI model 202A based on historical operation data, simulation environment, and virtual operational data, in accordance with an embodiment of the disclosure. FIG. 7 is explained in conjunction with elements from FIG. 1, FIG. 2, FIG. 3, FIG. 4A, FIG. 4B, FIG. 5A, FIG. 5B, and FIG. 6. With reference to FIG. 7, the operation may start at 702. The operations of the exemplary method may be executed by any computing system, for example, by the computer 102 of FIG. 1 or the system 202 of FIG. 2.

At 702, a historical operation data reception operation is executed. In the historical operation data reception operation, the system 202 is configured to receive historical operation data associated with a plurality of training conveyors. The plurality of training conveyors is exclusive of the conveyor 204. By way of example, and not by limitation, the system 202 is configured to receive the historical operation data associated with the operational history of a plurality of training conveyors, that may include or exclude conveyor 204. In an example, the historical operation data may be indicative of the performance of the plurality of training conveyors over a defined historical time period, specifically recording working conditions and performance of the plurality of training conveyors.

At 704, a simulation environment generation operation is executed. In the simulation environment generation operation, the system 202 is configured to generate a simulation environment based on the historical operation data. In an embodiment, the simulation environment may include a virtual conveyor having a plurality of virtual sections. Each virtual section of the plurality of virtual sections may include at least one virtual adjustable supporting structure. Further, the virtual conveyor is configured to move a plurality of virtual entities positioned thereon.

In an embodiment, the functionality of the virtual conveyor may be similar to the functionality of the conveyor 204 described in FIG. 2, and FIG. 3. Further, the plurality of virtual sections may be a virtual image of the plurality of sections 206. Each virtual section of the plurality of virtual sections may be the virtual image of each section of the plurality of sections 206 of the conveyor 204.

At 706, a virtual operational data determination operation is executed. In the virtual operational data determination operation, the system 202 is configured to determine the virtual operational data associated with the virtual conveyor. In an embodiment, the virtual operational data includes virtual weight data associated with each virtual section of the plurality of virtual sections, virtual noise data associated with the virtual conveyor and/or virtual speed data associated with the virtual conveyor. The virtual operational data is determined based on the generated simulation environment, where the virtual conveyor is configured to move the plurality of virtual entities from a first virtual location to a second virtual location. In an embodiment, the first virtual location is different from the second virtual location.

At 708, an AI model training operation is executed. In the AI model training operation, the system is configured to train the AI model 202A based on the historical operation data, the simulation environment, and the virtual operational data. The AI model 202A is trained to identify a virtual anomaly associated with the virtual conveyor.

In an embodiment, the system 202 is configured to train the AI model 202A using a dataset that includes the historical operation data, the generated simulation environment, and the virtual operational data. This training process may include the historical performance of the plurality of training conveyors, which may provide insights into historical operational behaviors and anomalies. The simulation environment may include the functionality of the virtual conveyor. This allows the AI model 202A to learn from virtual scenarios that replicate real-world conditions. By incorporating virtual weight data, the virtual noise data, and the virtual speed data associated with the virtual conveyor, the AI model 202A is trained to recognize patterns and deviations that may indicate potential anomalies. This may ensure that the AI model 202A can identify and predict virtual anomalies, thereby enhancing the overall reliability and efficiency of conveyor operations in real-time applications.

In an embodiment, to train the AI model 202A, the system 202 may employ various techniques including supervised learning, unsupervised learning, and reinforcement learning. In supervised learning, the AI model 202A may be trained on labeled historical operation data, where specific outcomes or anomalies are identified, allowing the AI model 202A to learn the relationship between input features (such as historical operating conditions) and expected outputs (such as historical anomalies). The unsupervised learning techniques can be utilized to discover hidden patterns or clusters within the historical operational data without predefined labels, enabling the AI model 202A to identify unusual behaviors that deviate from the normal operation of the conveyor 204. Additionally, reinforcement learning can be applied in the simulation environment, where the AI model 202A learns through trial and error by receiving feedback based on actions, optimizing performance in detecting anomalies over time. By combining these techniques, the AI model 202A can develop a robust understanding of operations of the conveyor 204, enhancing its ability to predict and identify anomalies and resolve the identified anomalies timely.

At 710, an AI model storage operation is executed. In the AI model storage operation, the system 202 is configured to store the trained AI model 202A. In an embodiment, the system 202 stores the trained AI model 202A within the memory of the system 202. In an alternate embodiment, the system 202 stores the trained AI model 202A in the database 208. In an embodiment, the system 202 may store the trained AI model 202A in memory of at least one aerial vehicle of the plurality of aerial vehicles.

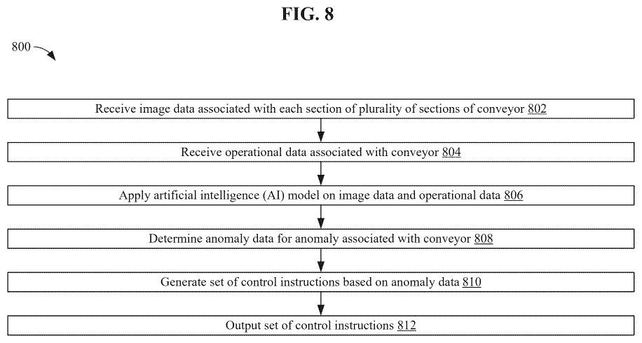

FIG. 8 is a diagram that illustrates a flowchart 800 of an exemplary method for the generation of the set control instructions 202B to control the operation of the conveyor 204, in accordance with an embodiment of the disclosure. FIG. 8 is explained in conjunction with elements of FIG. 1, FIG. 2, FIG. 3, FIG. 4A, FIG. 4B, FIG. 5A, FIG. 5B, FIG. 6, and FIG. 7. With reference to FIG. 8, there is shown a flowchart 800. The operations of the exemplary method may be executed by any computing system, for example, by the computer 102 of FIG. 1 or the system 202 of FIG. 2. The operations of the flowchart 800 may start at 802.

At 802, the image data 208A associated with each section of the plurality of sections 206 of the conveyor 204 is received. Each section of the plurality of sections 206 includes at least one adjustable supporting structure. The conveyor 204 is configured to move the plurality of entities positioned thereon. In an embodiment, the system 202 is configured to receive the image data 208A associated with each section of the plurality of sections 206 of the conveyor 204. Each section of the plurality of sections 206 includes at least one adjustable supporting structure. The conveyor 204 is configured to move the plurality of entities positioned thereon.

At 804, the operational data 208B associated with the conveyor 204 is received. In an embodiment, the system 202 is configured to receive the operational data 208B associated with the conveyor 204.

At 806, the AI model 202A is applied on the image data 208A and the operational data 208B. In an embodiment, the system, 202 is configured to apply the AI model 202A to the image data 208A and the operational data 208B.

At 808, the anomaly data for the anomaly associated with the conveyor 204 is determined. The anomaly data is determined based on the application of the AI model 202A. The anomaly is associated with at least one of a movement of the conveyor 204, the specific entity of the plurality of entities, or the at least one adjustable supporting structure of the specific section of the plurality of sections 206. In an embodiment, the system 202 is configured to determine the anomaly data for the anomaly associated with the conveyor 204. The anomaly data is determined based on the application of the AI model 202A. The anomaly is associated with at least one of the movements of the conveyor 204, the specific entity of the plurality of entities, or the at least one adjustable supporting structure of the specific section of the plurality of sections 206.

At 810, the set of control instructions 202B is generated based on the anomaly data. The set of control instructions 202B is associated with the operation of the conveyor 204. In an embodiment, the system 202 is configured to generate the set of control instructions 202B based on the anomaly data. The set of control instructions 202B is associated with the operation of the conveyor 204.

At 812, the set of control instructions 202B is outputted. In an embodiment, the system 202 is configured to output the set of control instructions 202B.

In various embodiments of the disclosure, a computer program product for the generation of control instructions to control an operation of a conveyor 204 is described. The computer program product includes a computer-readable storage media having program instructions stored on the computer-readable storage media to perform operations. The operations include receiving image data 208A associated with each section of a plurality of sections 206 of the conveyor 204. Each section of the plurality of sections 206 includes at least one adjustable supporting structure. The conveyor 204 is configured to move a plurality of entities positioned thereon. The operations further include receiving operational data 208B associated with the conveyor 204. The operations further include applying an artificial intelligence (AI) model 202A on the image data 208A and the operational data 208B. The operations further include determining anomaly data for an anomaly associated with the conveyor 204. The anomaly data is determined based on the application of the AI model 202A. The anomaly is associated with at least one of a movement of the conveyor 204, a specific entity of the plurality of entities, or the at least one adjustable supporting structure of a specific section of the plurality of sections. The operations further include generating a set of control instructions 202B based on the anomaly data. The set of control instructions 202B is associated with an operation of the conveyor 204. The operations further include outputting the set of control instructions 202B.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, image data associated with each section of a plurality of sections of a conveyor, wherein each section of the plurality of sections comprises at least one adjustable supporting structure, and wherein the conveyor is configured to move a plurality of entities positioned thereon;
receiving, by the computer, operational data associated with the conveyor;
applying, by the computer, an artificial intelligence (AI) model on the image data and the operational data;
determining, by the computer, anomaly data for an anomaly associated with the conveyor, wherein the anomaly data is determined based on the application of the AI model, and wherein the anomaly is associated with at least one of a movement of the conveyor, a specific entity of the plurality of entities, or the at least one adjustable supporting structure of a specific section of the plurality of sections;
generating, by the computer, a set of control instructions based on the anomaly data, wherein the set of control instructions is associated with an operation of the conveyor; and
outputting, by the computer, the set of control instructions.

2. The computer-implemented method of claim 1, further comprising:
receiving, by the computer, aerial vehicle data associated with each aerial vehicle of a plurality of aerial vehicles;
identifying, by the computer, a specific aerial vehicle of the plurality of aerial vehicles for resolving the anomaly, wherein the specific aerial vehicle is identified based on the anomaly data and the aerial vehicle data;
generating, by the computer, the set of control instructions for the specific aerial vehicle based on the anomaly data and the aerial vehicle data; and
controlling, by the computer, an operation of the specific aerial vehicle based on the set of control instructions.

3. The computer-implemented method of claim 2, wherein the operation of the specific aerial vehicle corresponds to resolving the anomaly, and wherein the operation of the specific aerial vehicle comprises one of removing the specific entity or changing a position of the specific entity.

4. The computer-implemented method of claim 1, further comprising:
determining, by the computer, entity data associated with each entity of the plurality of entities, wherein the entity data is determined based on the application of the AI model on the image data and the operational data; and
determining, by the computer, the anomaly data based on the entity data.

5. The computer-implemented method of claim 4, wherein the entity data comprises at least one of size data associated with each entity of the plurality of entities, weight data associated with each entity of the plurality of entities, shape data associated with each entity of the plurality of entities, fragility data associated with each entity of the plurality of entities, or chemical properties associated with each entity of the plurality of entities.

6. The computer-implemented method of claim 4, further comprising:
determining, by the computer, height data associated with the at least one adjustable supporting structure of the specific section, wherein the height data is determined based on the application of the AI model on the image data associated with each section of the plurality of sections of the conveyor;
determining, by the computer, size data associated with at least one entity of the plurality of entities, wherein the at least one entity is associated with the at least one adjustable supporting structure of the specific section, wherein the at least one entity is inclusive of the specific entity, and wherein the size data is determined based on the entity data;
generating, by the computer, the set of control instructions based on at least the height data and the size data; and
controlling, by the computer, the at least one adjustable supporting structure to execute an adjustment operation, wherein the adjustment operation is executed for adjusting a height of the at least one adjustable supporting structure, and wherein the controlling is based on the set of control instructions.

7. The computer-implemented method of claim 1, further comprising:
receiving, by the computer, historical operation data associated with a plurality of training conveyors, wherein the plurality of training conveyors is exclusive of the conveyor;
generating, by the computer, a simulation environment based on the historical operation data, wherein the simulation environment comprises a virtual conveyor having a plurality of virtual sections, wherein each virtual section of the plurality of virtual sections comprises at least one virtual adjustable supporting structure, and wherein the virtual conveyor is configured to move a plurality of virtual entities positioned thereon;
determining, by the computer, virtual operational data associated with the virtual conveyor;
training, by the computer, the AI model based on the historical operation data, the simulation environment, and the virtual operational data, wherein the AI model is trained to identify a virtual anomaly associated with the virtual conveyor; and
storing, by the computer, the trained AI model.

8. The computer-implemented method of claim 1, wherein the operational data comprises at least one of weight data associated with each section of the plurality of sections, noise data associated with the conveyor, or speed data associated with the conveyor.

9. The computer-implemented method of claim 1, wherein the anomaly data for the anomaly comprises at least one of a type associated with the anomaly, a location associated with the anomaly, or a resolution process associated with the anomaly.

10. The computer-implemented method of claim 9, further comprising controlling, by the computer, an execution of the resolution process at the location associated with the anomaly for resolving the anomaly, wherein the execution of the resolution process is based on the set of control instructions.

11. The computer-implemented method of claim 1, wherein the anomaly is indicative of a deviation from a pre-defined operating conditions associated with the at least one of the movement of the conveyor, the specific entity of the plurality of entities, or the at least one adjustable supporting structure of a specific section of the plurality of sections.

12. A computer system, comprising:
a processor set;
one or more computer-readable storage media; and
program instructions stored on the one or more computer-readable storage media, the program instructions executable by the processor set to cause the processor set to:
receive image data associated with each section of a plurality of sections of a conveyor, wherein each section of the plurality of sections comprises at least one adjustable supporting structure, and wherein the conveyor is configured to move a plurality of entities positioned thereon;
receive operational data associated with the conveyor;
apply an artificial intelligence (AI) model to the image data and the operational data;
determine anomaly data for an anomaly associated with the conveyor, wherein the anomaly data is determined based on the application of the AI model, and wherein the anomaly is associated with at least one of a movement of the conveyor, a specific entity of the plurality of entities, or the at least one adjustable supporting structure of a specific section of the plurality of sections;
generate a set of control instructions based on the anomaly data, wherein the set of control instructions is associated with an operation of at least one of the conveyor or an aerial vehicle; and
control the operation of at least one of the conveyor, or the aerial vehicle, based on the set of control instructions.

13. The computer system of claim 12, wherein the program instructions further cause the processor set to:
receive aerial vehicle data associated with each aerial vehicle of a plurality of aerial vehicles;
identify a specific aerial vehicle of the plurality of aerial vehicles to resolve the anomaly, wherein the specific aerial vehicle is identified based on the anomaly data and the aerial vehicle data;
generate the set of control instructions for the specific aerial vehicle based on the anomaly data and the aerial vehicle data; and
control an operation of the specific aerial vehicle based on the set of control instructions.

14. The computer system of claim 13, wherein the operation of the specific aerial vehicle corresponds to resolving the anomaly, and wherein the operation of the specific aerial vehicle comprises one of removal of the specific entity or change in a position of the specific entity.

15. The computer system of claim 12, wherein the program instructions further cause the processor set to:
determine entity data associated with each entity of the plurality of entities, wherein the entity data is determined based on the application of the AI model on the image data and the operational data; and
determine the anomaly data based on the entity data.

16. The computer system of claim 15, wherein the entity data comprises at least one of size data associated with each entity of the plurality of entities, weight data associated with each entity of the plurality of entities, shape data associated with each entity of the plurality of entities, fragility data associated with each entity of the plurality of entities, or chemical properties associated with each entity of the plurality of entities.

17. The computer system of claim 15, wherein the program instructions further cause the processor set to:
determine height data associated with the at least one adjustable supporting structure of the specific section, wherein the height data is determined based on the application of the AI model on the image data associated with each section of the plurality of sections of the conveyor;
determine size data associated with at least one entity of the plurality of entities, wherein the at least one entity is associated with the at least one adjustable supporting structure of the specific section, wherein the at least one entity is inclusive of the specific entity, and wherein the size data is determined based on the entity data;
generate the set of control instructions based on at least the height data and the size data; and
control the at least one adjustable supporting structure to execute an adjustment operation, wherein the adjustment operation is executed to adjust a height of the at least one adjustable supporting structure, and wherein the control is based on the set of control instructions.

18. The computer system of claim 12, wherein the program instructions further cause the processor set to:
receive historical operation data associated with a plurality of training conveyors, wherein the plurality of training conveyors is exclusive of the conveyor;
generate a simulation environment based on the historical operation data, wherein the simulation environment comprises a virtual conveyor with a plurality of virtual sections, wherein each virtual section of the plurality of virtual sections comprises at least one virtual adjustable supporting structure, and wherein the virtual conveyor is configured to move a plurality of virtual entities positioned thereon;
determine virtual operational data associated with the virtual conveyor;
train the AI model based on the historical operation data, the simulation environment, and the virtual operational data, wherein the AI model is trained to identify a virtual anomaly associated with the virtual conveyor; and
store the trained AI model.

19. The computer system of claim 12, wherein the operational data comprises at least one of weight data associated with each section of the plurality of sections, noise data associated with the conveyor, or speed data associated with the conveyor.

20. A computer program product for controlling an operation of a conveyor, the computer program product comprising:
one or more computer-readable storage media; and
program instructions stored on the one or more computer-readable storage media to perform operations comprising:
receiving image data associated with each section of a plurality of sections of the conveyor, wherein each section of the plurality of sections comprises at least one adjustable supporting structure, and wherein the conveyor is configured to move a plurality of entities positioned thereon;
receiving operational data associated with the conveyor;
applying an artificial intelligence (AI) model on the image data and the operational data;
determining anomaly data for an anomaly associated with the conveyor, wherein the anomaly data is determined based on the application of the AI model, and wherein the anomaly is associated with at least one of a movement of the conveyor, a specific entity of the plurality of entities, or the at least one adjustable supporting structure of a specific section of the plurality of sections;
generating a set of control instructions based on the anomaly data, wherein the set of control instructions is associated with an operation of the conveyor; and
outputting the set of control instructions.
